(19) United States
(12) Patent Application Publication
(10) Pub. No.: US 2022/0268671 A1
(43) Pub. Date: Aug. 25, 2022

(54) A DEVICE FOR IMMOBILIZING RARE CELLS FOR CYTOLOGY

(71) Applicant: Rare Cell Technologies Pty Ltd, Carlingford, New South Wales (AU)

(72) Inventors: Tony PANG, Sydney (AU); Joseph William PO, Sydney (AU)

(73) Assignee: Rare Cell Technologies Pty Ltd, Carlingford, New South Wales (AU)

(21) Appl. No.: 17/639,354

(22) PCT Filed: Aug. 28, 2020
(86) PCT No.: PCT/AU2020/050912

§ 371 Date: Mar. 1, 2022

(51) Int. Cl. G01N 1/28; B01L 3/00

(52) U.S. Cl. CPC G01N 1/2813; B01L 3/5021; B01L 2200/0689; B01L 2300/042; B01L 2300/046; B01L 2300/0609; G01N 2001/2846

(57) ABSTRACT

A device of immobilising and concentrating cells from cell suspensions by centrifugation using a standard centrifuge having a plurality of centrifuge tubes having respective closing lids, the device comprising: one or more funnel units, each having a broad side and a narrow side, adapted to receive one or more fluids samples; one or more hollow cylinder, having a plurality of external threads on lateral surface of the cylinder, attached at the narrow side of the each of the respective one or more funnel unit, enclosing the narrow side of the respective one or more funnel unit; one or more removable gasket disposed on the narrow side encircling circumference of the narrow side of each of the one or more funnel unit; one or more coverslip holding plate, adapted to hold a respective coverslip, deployed proximal to the circumference of the narrow side of the respective one or more funnel unit; and one or more removable caps having a plurality of internal thread, adapted to enclose the respective one or more coverslip holding plates along with the respective coverslip, configured to fasten over the respective one or more hollow cylinder; wherein the one or more removable gasket is adapted to restrict leaking of the one or more fluid samples inside the one or more funnel units.

### TECHNICAL FIELD

The present invention generally relates to a mechanism for immobilising cells onto a substrate by centrifugation using a standard centrifuge having a plurality of centrifuge tubes having respective closing lids.

### BACKGROUND

Cytopathology (or cytology) is a branch of pathology that studies and diagnoses diseases on the cellular level and is generally used on samples of free cells or tissue fragments. Cytopathology is commonly used to investigate diseases involving a wide range of body sites, often to aid in the diagnosis of cancer but also in the diagnosis of some infectious diseases and other inflammatory conditions.

Cytopathologic tests are also referred to as smear tests as the samples are typically smeared across a glass microscope slide for subsequent staining and microscopic examination. Cytology samples may also be prepared in other ways including cytocentrifugation. Different types of smear tests may also be used for cancer diagnosis. In this sense, it is termed a cytologic smear.

Cytology allows the diagnosing of diseases by looking at single cells and small clusters of cells is increasingly used in diagnosing some types of cancer. Cytology specimens have advantages over tissue biopsies as they are typically easier to obtain. cause less discomfort to the patient; are less likely to result in serious complications to the patient; and costs less to implement.

Cytology tests may be used for diagnosis or for screening purposes. A diagnostic test is used on patients who have signs, symptoms or some other reason to suspect that they might have a particular disease such as cancer. A diagnostic test determines if a disease is present and, if so, attempts to precisely and accurately classify the disease. A screening test is used as an early detection means to detect a certain disease even before a patient develop symptoms. A diagnostic test is typically initiated if a screening test results in a positive result, meaning that something is found on the screening test.

Some cytology tests, such as the Pap smear test, are used for screening while others can accurately identify diseases such as cancers. When cytology results show cancer, often a biopsy is also done to be sure before treatment is started.

The following fluids are typically used in cytology tests: urine; sputum (phlegm); spinal fluid; pleural fluid (from the space around the lungs); pericardial fluid (from the sac that surrounds the heart); and ascitic (from the space in the abdomen). Once collected, the cytology specimens need to be deposited onto a coverslip, slide or other substrate for analysis. The specimens are typically transferred onto the slides by techniques such as direct smear, touch preps or filter techniques.

Alternatively, a cytocentrifuge can be used to deposit cells evenly onto a glass slide. This produces a monolayer cell deposition in a defined area of the slide using centrifugal force. Using cytocentrifugation consistently produces uniform preparations of cells that are easily stained and evaluated. Cytocentrifugation can be expensive due to the need for capital investment in the centrifuge machine and may not be widely available in standard laboratories.

Traditional methods of preparing samples are also not suitable for preparation of certain samples. Prior art systems assume the use of centrifuge specimens having a significant number of cells (in the thousands) and could be concentrated in a small volumes (<0.5 mL). In some applications, such as with circulating tumour cell (CTC) research there may be only a small number of cells in a sample, such as only one or two cells which may be found in a much larger volume. This means that maximising cell recovery without cell damage is exceedingly important. As such, existing systems, including cytocentrifugation, are not adequate for preparation of certain samples. Furthermore, these CTCs may be subject to sensitive molecular testing, high resolution imaging techniques, or tissue culture processes, which require cell specimens to maintain physiological characteristics to ensure robust analysis.

Therefore, there is a need in the art for a device for immobilising these cells in order to overcome above mentioned deficiencies of the existing solutions.

Throughout this specification, unless the context requires otherwise, the words “comprise”, “comprises” and “comprising” will be understood to imply the inclusion of a stated step or element or group of steps or elements but not the exclusion of any other step or element or group of steps or elements.

Any one of the terms: “including” or “which includes” or “that includes” as used herein is also an open term that also means including at least the elements/features that follow the term, but not excluding others.

Any discussion of the background art throughout the specification should in no way be considered as an admission that such background art is prior art nor that such background art is widely known or forms part of the common general knowledge in the field in Australia or worldwide.

### SUMMARY

According to a first aspect of the present invention, there is provided a device for immobilising cells by centrifugation using a standard centrifuge having a plurality of centrifuge tubes having respective closing lids, the device comprises one or more funnel units, each having a broad side and a narrow side, adapted to receive one or more fluids samples, one or more hollow cylinder, having a plurality of external threads on lateral surface of the cylinder, attached at the narrow side of the each of the respective one or more funnel unit, enclosing the narrow side of the respective one or more funnel unit, one or more attached gasket disposed on the narrow side encircling circumference of the narrow side of each of the one or more funnel unit, one or more coverslip holding plate, adapted to hold a respective coverslip or substrate, deployed proximal to the circumference of the narrow side of the respective one or more funnel unit and one or more removable caps having a plurality of internal thread, adapted to enclose the respective one or more coverslip holding plates along with the respective coverslip, configured to fasten over the respective one or more hollow cylinder. The one or more gasket is adapted to restrict leaking of the one or more fluid samples inside the funnel unit. In some embodiments the funnel is cylindrical. In some embodiments the substrate can be any suitable substrate onto which cells can be further processed including a culture plate, a plate with extracellular matrix, a non-adherent plate for cell picking or non-adherent culture.

Preferably, each of the one or more funnel units along with the one or more hollow cylinder, the one or more gasket, the one or more coverslip holding plate, the respective coverslips and the one or more removable caps are placed inside each of the respective centrifuge tubes of the standard centrifuge with the lids closed.

Preferably, the standard centrifuge is configured to immobilise a number of samples inside the one or more funnel unit using centrifugal force by pushing the cell sample toward the coverslip.

Preferably, the coverslip is placed in horizontal position inside the one or more funnel units.

Preferably, the narrow side of the one or more funnel units having a first set of rabbets adapted to hold the one or more removable gasket.

Preferably, the one or more coverslip holding plate having a second set of rabbets adapted to hold the respective one or more removable caps.

Preferably, the one or more coverslips holding plate further having a third set of rabbets adapted to hold the coverslip.

Preferably, the separated one or more cells in the sample are collected on the coverslip.

Preferably, each of the one or more funnel units comprising a flattened lateral surface running from the broad side to halfway towards the narrow side.

Preferably, the flattened lateral surface further includes grooves adapted to fix inside each of the respective centrifuge tubes to rigidify each of the one or more funnel units inside each of the respective centrifuge tubes while the centrifugation.

Preferably, the one or more fluid sample is selected from a group comprising plasma, serum, urine, sputum, spinal fluid, pleural fluid, pericardial fluid, and ascitic.

Preferably, the device may further include a quality control mechanism configured to alert a user of possible loss of the one or more fluid sample.

Preferably, the device further coated with a non-stick material.

Preferably, the sample substrate plate may further be coated with a non-stick material and a fluid-bounding mechanism configured to prevent the fluid sample loss after centrifugation. This will concentrate the cellular suspension and allow downstream processing such as cell picking where cells need to be in a suspension rather than being immobilised on glass.

### BRIEF DESCRIPTION OF DRAWINGS

At least one example of the invention will be described with reference to the accompanying drawings, in which:

FIG. 1 illustrates a device for separation of fluids, in accordance with an embodiment of the present invention;

FIG. 2A illustrate a side view of a funnel unit, in accordance with an embodiment of the present invention;

FIG. 2B illustrate a front view of the funnel unit, in accordance with an embodiment of the present invention;

FIG. 2C illustrates a bottom view of the funnel unit, in accordance with an embodiment of the present invention;

FIG. 2D illustrates a top view of the funnel unit, in accordance with an embodiment of the present invention;

FIG. 3 illustrates a cross sectional view of the funnel unit, in accordance with an embodiment of the present invention;

FIG. 4 illustrates an implementation of the device, in accordance with an embodiment of the present invention;

FIG. 5 illustrates cell recovery for low cell count samples, in accordance with an embodiment of the present invention;

FIG. 6 illustrates total sample loss, in accordance with an embodiment of the present invention;

FIG. 7 illustrates maintained morphology of cells, in accordance with an embodiment of the present invention; and

FIG. 8 illustrates cells maintained viability of cells, in accordance with an embodiment of the present invention; and

FIG. 9 illustrates a further device for immobilisation of cells, in accordance with an embodiment of the present invention.

It should be noted that the same numeral represents the same or similar elements throughout the drawings.

### DESCRIPTION OF EMBODIMENTS

The present invention aims to provide a device for immobilising or concentrating cells using a standard centrifuge having a plurality of centrifuge tubes (standard conical centrifuge tubes) having respective closing lids. A standard centrifuge is a laboratory device that is used for the separation of fluids, gas or liquid, based on density. Separation is achieved by spinning a vessel containing material at high speed thereby causing the centrifugal force to push heavier materials to the outside of the vessel. Centrifuges are common in most laboratories including in academic, clinical and research areas and are used to purify or concentrate cells, subcellular organelles, viruses, proteins, and nucleic acids. There are multiple types of centrifuges which are typically classified by intended use or rotor design. The invention is a device/adaptor to allow samples to be prepared onto a coverslip/glass slide/substrate using a standard centrifuge. It is designed to centrifuge a large volume of a cell suspension with minimal cell loss. In particular, it is useful for immobilising rare cells within a large volume specimen or concentrating such large volume specimens into a smaller volume with no cell loss. The device fits into a standard conical centrifuge tube (“Falcon tubes”).

In some embodiments the funnel is cylindrical.

In some embodiments the substrate can be any suitable substrate onto which cells can be further processed including a glass plate, a culture plate, a plate with extracellular matrix, a non-adherent plate for cell picking or non-adherent culture, a decellularized matrix sheet.

In this regard the invention below has been discussed with the help of figures for clarity. However, a skilled addressee would appreciate that the invention is not limited to particular types of implementations that have been discussed below and may be equally applicable to many different implementations without departing from the scope of the present invention.

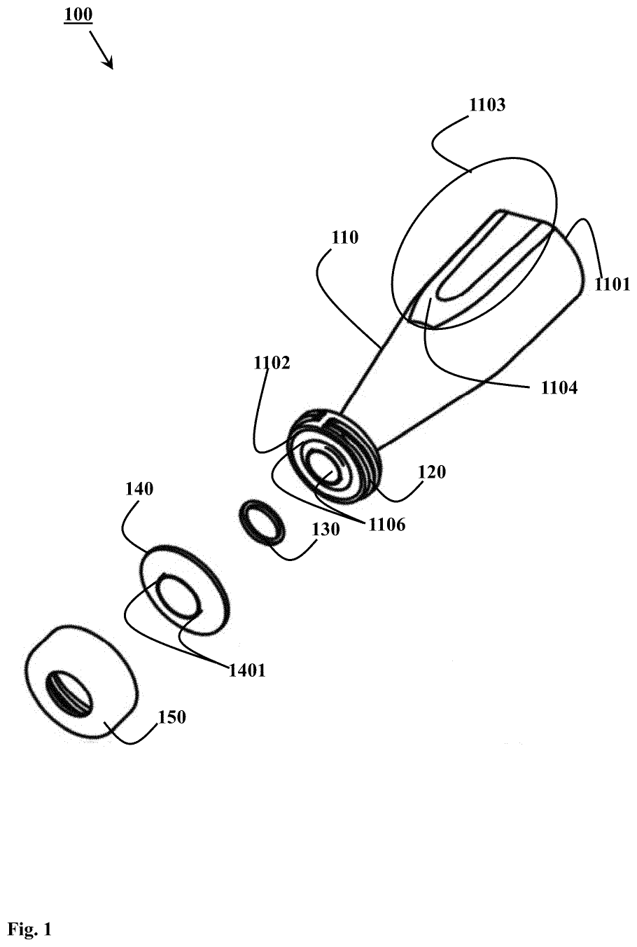

FIG. 1 illustrates a device 100 for immobilisation of cells (hereinafter referred as “the device 100”), in accordance with an embodiment of the present invention. The device 100 for immobilisation of cells by centrifugation uses a standard centrifuge (not shown). The standard centrifuge may have a plurality of centrifuge tubes (not shown in this figure) having respective closing lids. The device 100 comprises one or more funnel units 110, one or more hollow cylinder 120, one or more removable gasket 130, one or more coverslip holding plate 140, one or more removable caps 150, one or more coverslips (not shown in this figure). The device 100 may be coated with a non-stick material(s) such as, but not limited to, Pluronic F127, polytetrafluoroethylene (PTFE), ceramic. Particularly on the interior of the device, the non-stick material aids in ensuring the cells within the samples do not stick to the side walls of the funnel.

The coverslip holding plate 140 may be coated in a hydrophobic layer which allows a user to directly perform immunocytochemistry on the coverslip. This allows the user, when performing staining, to put in antibodies and other solutions on the coverslip. Through the holding plate being hydrophobic the added solution will form a meniscus on the coverslip and be limited by the edges of the coverslip.

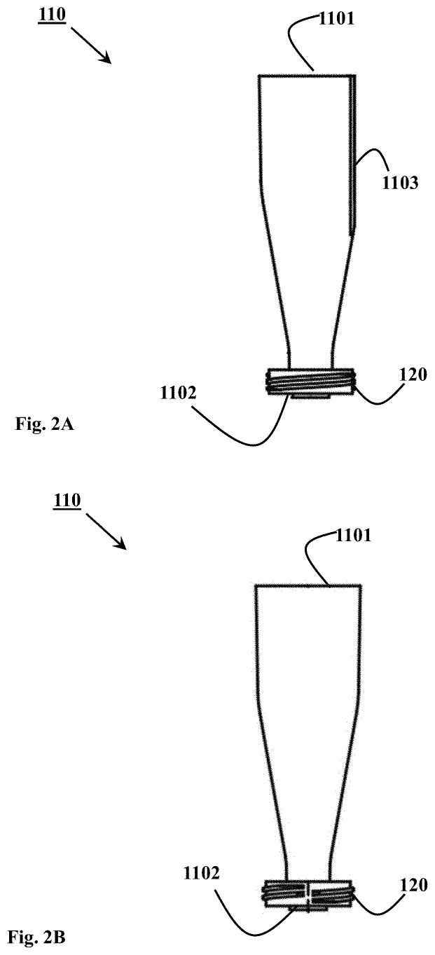

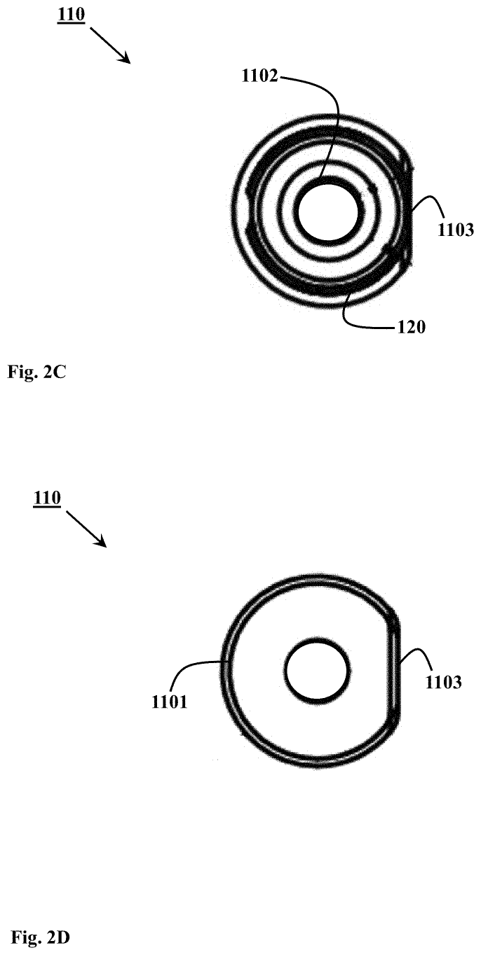

Further, FIG. 2C illustrates a bottom view of the funnel unit, in accordance with an embodiment of the present invention. FIG. 2D illustrates a top view of the funnel unit, in accordance with an embodiment of the present invention. As shown in FIG. 1 and FIG. 2C-2D each of the one or more funnel units 110 have a broad side 1101 and a narrow side 1102. The one or more funnel units 110 made of may be, but not limited to, non-reactive, non-corrosive and anti-adhesive material such as plastic, PVC, stainless steel, aluminium, glass.

Further, the one or more funnel units 110 may have a flattened lateral surface 1103. FIG. 2A illustrate a side view of a funnel unit, in accordance with an embodiment of the present invention. As shown in FIG. 2A, the flattened lateral surface 1103 runs from the broad side 1101 to halfway towards the narrow side 1102. The flattened lateral surface 1103 may further have one or more grooves 1104. The one or more grooves 1104 may be, but not limited to, a grip made of rubber, engraving, protrusion. The one or more grooves 1104 may be adapted to fix inside each of the respective centrifuge tubes (not shown in this figure). Additionally, the flattened lateral 1103 surface may be adapted to prevent the one or more funnel units 110 from getting jammed inside the centrifuge tube. Furthermore, the flattened lateral surface can act as a handle for removal with some type of forceps.

The one or more grooves 1104 may rigidify each of the one or more funnel units 110 inside each of the respective centrifuge tubes while the centrifugation. The one or more funnel units 110 may be adapted to receive one or more fluids samples. The one or more fluid sample is selected from a group comprising serum, plasma, urine, sputum, spinal fluid, pleural fluid, pericardial fluid, and ascitic. Further, the narrow side 1102 of the one or more funnel units 110 may have a first set of rabbets 1106. Moreover, the one or more funnel units 110 may include circumferential rim 1107 proximal to the first set of rabbets 1106. The circumferential rim may be adapted to reduce chance of cells getting stuck to the gasket 130. FIG. 2B illustrate a front view of the funnel unit 110, in accordance with an embodiment of the present invention. As shown in FIG. 1 and FIG. 2B, further, the narrow side 1102 of the respective one or more funnel unit 110 is attached with the one or more hollow cylinder 120.

The one or more hollow cylinder 120 may have a plurality of external threads on lateral surface of the cylinder. The one or more hollow cylinder 120 may enclose the narrow side 1102 of the respective one or more funnel unit 110. Further, each of the one or more funnel unit 110 may have the one or more removable gasket 130 disposed on the on the narrow side 1102 encircling circumference of the narrow side 1102 of each of the one or more funnel unit 110. The one or more removable gasket 130 made of may be, but not limited to, silicone, rubber, plastic, PVC.

In addition, the narrow side 1102 of the respective one or more funnel unit 110 may have the one or more coverslip holding plate 140 deployed proximal to the circumference of the narrow side 1102 of the respective one or more funnel unit 110. The one or more coverslip holding plate 140 adapted to hold a respective coverslip (not shown in this figure). The coverslips are envisaged to include a square coverslip, a rectangular coverslip, circular coverslips of variable thickness. The coverslip holding plate 140 may further be adapted to hold small glass/plastic containers with a short rim. However, in the preferred embodiment, the circular coverslips may be used. The coverslips may be placed in a horizontal position inside the one or more funnel units 110. The one or more coverslip holding plate 140 may have a second set of rabbets 1401. The second set of rabbets may be adapted to hold the one or more coverslip holding plate 140 on to the one or more removable cap 150.

The respective coverslips may be held in place with the help of a third set of rabbets (not shown) disposed on each of the one or more coverslip holding plate 140. The coverslip rests on the coverslip holding plate 140 which in turn is held in place by the one or more removable caps 150 being supported by the second set of rabbets 1401, on the other side of the respective one or more coverslip holding plate 140. The coverslips made of material such as may be, but not limited to, glass, plastic, quartz, anti UV glass. Moreover, the one or more coverslip holding plates 140 and the coverslip are enclosed inside the one or more removable caps 150. The one or more removable caps 150 may have a plurality of internal or external threads. The one or more removable caps 150 may be adapted to enclose the respective one or more coverslip holding plates 140 and the respective coverslip.

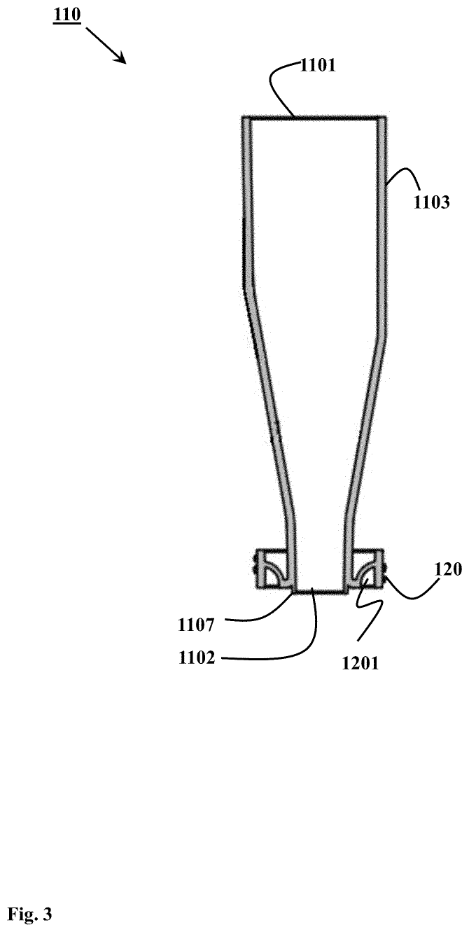

FIG. 3 illustrates a cross sectional view of the funnel unit, in accordance with an embodiment of the present invention. As illustrated in FIG. 3, each of the one or more funnel units 110 along with the one or more hollow cylinder 120, the one or more removable gasket 130, the one or more coverslip holding plate 140, the respective coverslips (not shown in this figure) and the one or more removable caps 150 are assembled. Furthermore, as shown in FIG. 3, the one or more funnel units 110 may comprise a cavity 1201 formed in between the enclosure of the one or more hollow cylinder 120 and encircling circumference of the narrow side 1102. The cavity 1201 may be adapted to fit a non-stick coverslip/container with a rim. The non-stick coverslip/container may allow concentration of a cell suspension, for, but not limited to, cell picking and for adherent or non-adherent cell culture.

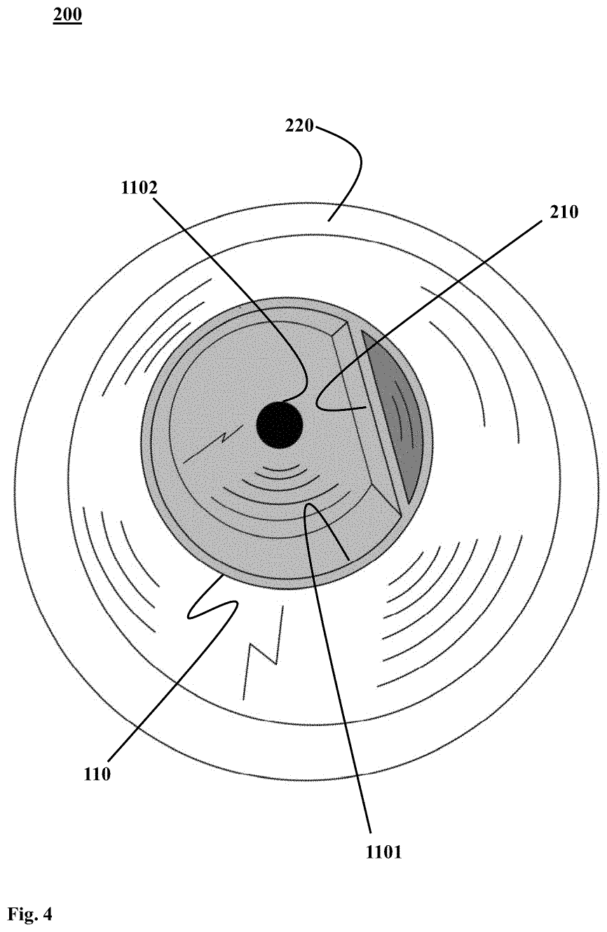

FIG. 4 illustrates implementation of the device, in accordance with an embodiment of the present invention. As shown in FIG. 4, the one or more fluid samples are put inside the one or more funnel units 110. The assembled each of the one or more funnel units 110 with the one or more fluid samples along with the one or more hollow cylinder 120, the one or more removable gasket 130, the one or more coverslip holding plate 140, the respective coverslips 210 and the one or more removable caps 150 are placed inside each of the respective centrifuge tubes 220 of the standard centrifuge with the lid closed (figure illustrates the view from the opening of the centrifuge tube 220, without a lid).

The grooves 1104 on the one or more funnel units 110 provides grip to the one or more funnel unit 110 inside the centrifuge tube. The grooves 1104 may prevent the one or more funnel units 110 from wobbling inside the centrifuge tubes 220. The standard centrifuge may use centrifugal force to push the cells within the fluid samples toward the coverslip 210. The immobilised cell samples are collected on the coverslip 210. After the collection of the cell sample on the coverslip 210, the coverslip 210 may be retrieved by unscrewing the removable cap 150 and removing the coverslip holding plate 140.

the device 100 may include a filter (not shown). The filter may be disposed between the broad side 1101 of the one or more funnel unit 110 and the respective coverslip. In one embodiment, the filter may be placed in the middle portion of each of the one or more funnel units 110. The filter may be adapted to allow the capture of cells on the filter during the centrifugation process, with the non-filtered cells immobilised on the coverslip.

Additionally, the device 100 may include a quality control mechanism (not shown). The quality control mechanism may be in built inside each of the one or more funnel units 110. The quality control mechanism may be configured to alert a user of possible loss of the one or more fluid sample. In one embodiment, the failure of the sealing mechanism (with gasket 130) will lead to the leakage of fluid into the bottom of the conical centrifuge tube (220) thus alerting the user there is a possible loss of some of cells within the fluid sample.

Moreover, the device 100 may include a fluid-bounding mechanism. The fluid-bounding mechanism may be configured on the sample collection container to prevent the one or more fluid sample loss during the centrifugation. This may concentrate the cellular suspension and allow downstream processing such as cell picking where cells need to be in a suspension rather than being immobilised on glass.

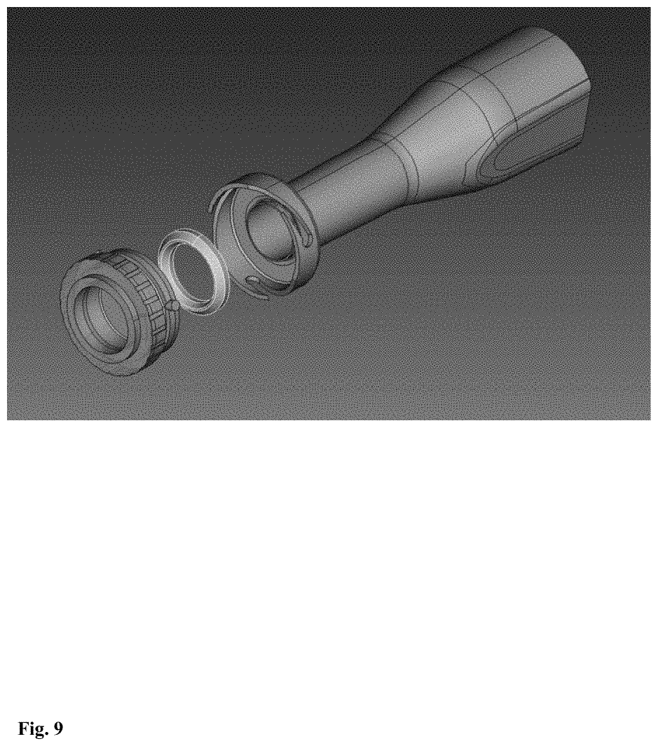

FIG. 9 illustrates a further embodiment of the invention. This embodiment provides different mechanisms for securing the funnel and in particular, the base with coverslip holder by use of a cap with a quarter turn twist-lock. Other types of clip lock or click locking means, with various numbers of locking parts, are also suitable. In this embodiment the coverslip holder is textured to allow easy gripping and turning of the part. The securing mechanism is using a quarter turn twist lock. This twist lock ensures optimal compression of the gasket to form a tight seal (without placing too much pressure on the coverslip, which might fracture it). It also provides feedback to the user that optimal seal has been achieved.

The gasket is made of silicone and forms a seal on the coverslip. The underside of the funnel has a lip, which protrudes beyond the attachment for the gasket to reduce the likelihood of cells being caught by the gasket bulging inwards. The flat part of the funnel allows the funnel to be easily removed from the conical centrifuge tube after centrifugation.

Other means can be used to seal the holding plate 140 in addition to gasket 130 including using a compressible substrate instead of coverslip being the use of the target substrate to seal the narrow side 1102 of funnel unit 110.

In order to improve distribution of cells some embodiments including multiple fins on the inside of the funnel unit to allow more uniform distribution of cells especially for higher cell count samples. The fins are preferably located concentric to the funnel wall in order to guide the cells towards the centre of the funnel to prevent localised concentration of cells at the circumference of the coverslip.

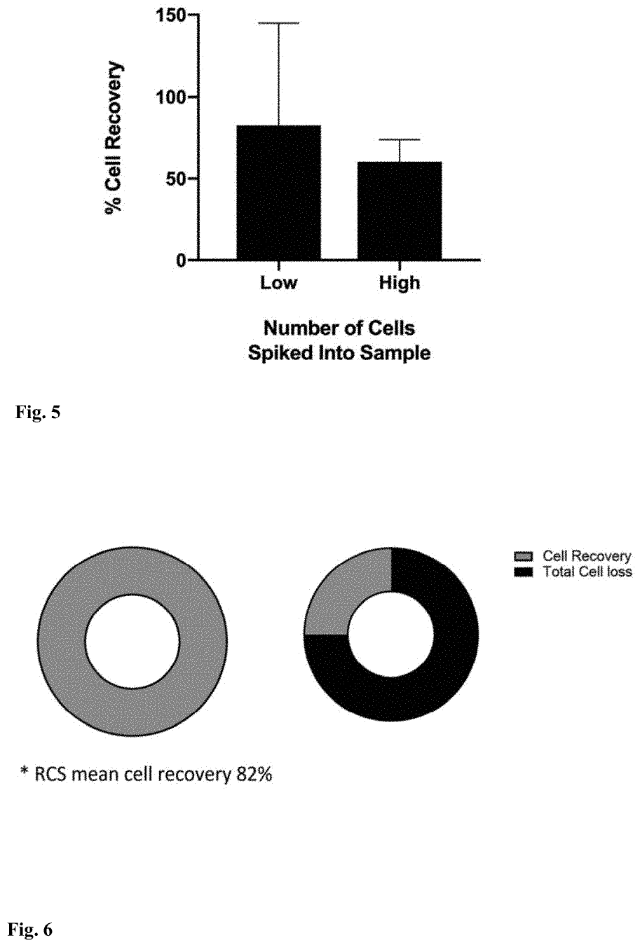

FIG. 5 illustrates cell recovery results for low cell count samples (Low=<10 cells within sample; High=>10 cells but less than 200 cells). This figure shows the proportion of spiked cultured cells that were recovered following cytocentrifugation using the device according to the preferred embodiment of the invention. “Low” is defined as 10 or fewer cells spiked into suspension; “high” defined as more than 10, but less than 200 cells. Cell suspension consists of cells from a cancer cell line in phosphate buffered solution. This figure demonstrates the high cell recovery efficiency using the invention in both small cell and high cell numbers.

FIG. 6 illustrates Total sample loss compared to CytocSpin Cytocentifuge (current cytocentrifugation gold standard). N=4 each. This figure shows the proportion of spiked cultured cells that were lost during the cytocentrifugation process for samples with very low cell counts (<10 cells) comparing the device of the preferred embodiment and the gold standard tool CytoSpin (ThermoFisher). Light grey areas represent proportion of cell sample recovered; black areas represent proportion of cell sample lost. This figure demonstrates the marked reduction in the proportion of samples suffering from total sample cell loss following cytocentrifugation using this Device as compared with the gold standard CytoSpin (ThermoFisher).

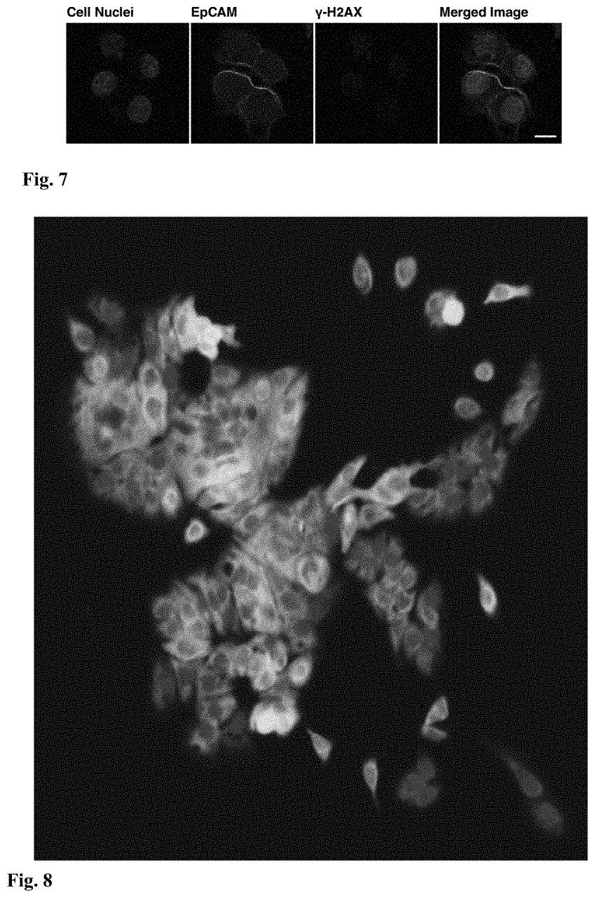

FIG. 7 demonstrates maintained morphology. This figure illustrates representative fluorescent confocal microscopy image depicting imaging of circulating tumour cells after cytocentrifugation with the device of the preferred embodiment. These images depict four human breast cancer cells (MCF-7) that were spiked into healthy donor whole blood to model CTCs and then irradiated (8 Gy dose). biomarker staining of cultured breast cancer cells that were subject to cytocentrifugation using the device of the preferred embodiment. Each tile in the figure represents staining using a different marker: Cell surface marker (epithelial cell adhesion molecular [EpCAM]) in green, cell nuclei or DNA stain in blue, gamma-H2Ax foci (a marker for the response to double-strand DNA breaks) in red. The final tile represents the merged image. Scale bar is 10 μm. These microscopy image tiles demonstrates that cell morphology is maintained, as indicated by defined and expected staining pattern of these cell biomarkers, following cytocentrifugation using the device according to the preferred embodiment of the invention.

FIG. 8 is an Immunocytochemistry image of cultured CTCs (Green=pan-cytokeratin; Blue=nuclear stain) and demonstrates cell viability post immobilization using the preferred embodiment of the invention. In this experiment, blood from an orthotopic mouse model of pancreatic cancer was enriched for circulating tumour cells (CTC). The enriched sample fraction was transferred to the device to allow cell immobilisation on a coverslip by centrifugation. Successful culture of these cells confirms cell viability following cytocentrifugation. Further, using this same orthotopic mouse model of pancreatic cancer, it has been demonstrated that this device can be used for CTC ex-vivo culture with a high success rate of 42% (5/12).

The present invention offers a number of advantages. Firstly, it provides a cost effective and easy to implement solution to the existing problems. It is an advantage of the present invention that the present invention allows centrifugation of large volumes. The invention minimises loss of one or more cell samples. The present invention helps in reduction of shear stresses on cells inside the fluid samples, thereby maintaining cell viability and reduced distortion of the cell morphology. The present invention can be used in any laboratory without extra capital expenditure. Most biomedical laboratories have centrifuges which uses conical centrifuge tubes (“Falcon” tubes) which are compatible with the present invention.

The invention is easy to use. It has an inbuilt “quality control” in that leaks can be seen and alerts the user to possible cell loss. The inside wall of the adaptor does not allow the cell samples to stick to the walls of the funnel units. Hence, less wastage of the cell samples. Tests on the prototypes suggest 60-100% cell recovery. Cells recovered have normal morphology and, in many cases, maintain their viability, as demonstrated by the ability to propagate them with tissue culture techniques. The present invention maximises the yield of cells recovery on the coverslip. The flexibility of the present invention to be used with a standard centrifuge and standard tubes inside the centrifuge dramatically increases the cost-effectiveness of the present invention. The invention hence can be used in such medical institutes where there is lack of special equipment for cytocentrifugation. Moreover, the leak proof design of the present invention ensures the maximum deposition of the cells of fluid sample on the coverslips. In addition, embodiments of the invention provide minimal disruption to the cells within the sample in addition to minimal cell loss.

The terms and descriptions used herein are set forth by way of illustration only and are not meant as limitations. Examples and limitations disclosed herein are intended to be not limiting in any manner, and modifications may be made without departing from the spirit of the present disclosure. Those skilled in the art will recognize that many variations are possible within the spirit and scope of the disclosure, and their equivalents, in which all terms are to be understood in their broadest possible sense unless otherwise indicated.

Various modifications to these embodiments are apparent from the description to those skilled in the art. The principles associated with the various embodiments described herein may be applied to other embodiments. Therefore, the description is not intended to be limited to the embodiments but is to be providing broadest scope consistent with the principles and the novel and inventive features disclosed and/or suggested herein. Accordingly, the invention is anticipated to hold on to all other such alternatives, modifications, and variations that fall within the scope of the present invention.

We claim:

1. A device of immobilising and concentrating cells from cell suspensions by centrifugation using a standard centrifuge having a plurality of centrifuge tubes having respective closing lids, the device comprising:
one or more funnel units,
each having a broad side and a narrow side, adapted to receive one or more fluids samples, and
each of the one or more funnel units comprising a flattened lateral surface;
one or more hollow cylinder, having a plurality of external threads on lateral surface of the cylinder, attached at the narrow side of the each of the respective one or more funnel unit, enclosing the narrow side of the respective one or more funnel unit;
one or more removable gasket disposed on the narrow side encircling circumference of the narrow side of each of the one or more funnel unit;
one or more coverslip holding plate, adapted to hold a respective coverslip, deployed proximal to the circumference of the narrow side of the respective one or more funnel unit; and
one or more removable caps having a plurality of internal or external threads, adapted to enclose the respective one or more coverslip holding plates along with the respective coverslip, configured to fasten over the respective one or more hollow cylinder;
wherein the one or more removable gasket is adapted to restrict leaking of the one or more fluid samples inside the one or more funnel units.

2. The device as claimed in claim 1, wherein each of the one or more funnel units along with the one or more hollow cylinder, the one or more removable gasket, the one or more coverslip holding plate, the respective coverslips and the one or more removable caps are placed inside each of the respective centrifuge tubes of the standard centrifuge with the lids closed.

3. The device as claimed in claim 1, wherein the standard centrifuge is configured to immobilise cells or concentrate cells inside the one or more funnel unit using centrifugal force by pushing the cells in the fluid sample toward the coverslip.

4. The device as claimed in claim 1, wherein the coverslip is placed in horizontal position inside the one or more funnel units.

5. The device as claimed in claim 1, wherein the narrow side of the one or more funnel units having a first set of rabbets adapted to hold the one or more removable gasket.

6. The device as claimed in claim 1, wherein the one or more coverslip holding plate having a second set of rabbets adapted to hold the respective one or more coverslips holding plate inside the one or more removable caps.

7. The device as claimed in claim 1, wherein the one or more coverslips holding plate further having a third set of rabbets adapted to hold the coverslip.

8. The device as claimed in claim 7, wherein the one or more coverslips holding plate further be coated in a hydrophobic layer to allow the user to directly perform immunocytochemistry on the plate.

9. The device as claimed in claim 3, wherein the immobilised cells are collected on the coverslip or other receptacle.

10. The device as claimed in claim 1, wherein the flattened lateral surface is located on the broad side of each of the one or more funnel units.

11. The device as claimed in claim 1, wherein the flattened lateral surface extends approximately halfway along each of the one or more funnel units from the broad side towards the narrow side.

12. The device as claimed in claim 11, wherein the flattened lateral surface further having grooves adapted to fix inside each of the respective centrifuge tubes to rigidify each of the one or more funnel units inside each of the respective centrifuge tubes while the centrifugation.

13. The device as claimed in claim 1, further including a filter, disposed between the broad side of the one or more funnel unit and the respective coverslip, configured to allow the capture of cells on the filter during the centrifugation process, with the non-filtered cells immobilised on the coverslip.

14. The device as claimed in claim 1, wherein the one or more fluid sample is selected from a group comprising urine, sputum, spinal fluid, pleural fluid, pericardial fluid, and ascitic.

15. The device as claimed in claim 1, further including a quality control mechanism configured to alert a user of possible loss of the one or more fluid sample.

16. The device as claimed in claim 1, further coated with a non-stick material.

17. The device as claimed in claim 1, further including a fluid bounding mechanism on the sample collection container configured to prevent the one or more fluid sample loss during the centrifugation.
